(19) United States
(12) Patent Application Publication
(10) Pub. No.: US 2026/0004202 A1
(43) Pub. Date: Jan. 1, 2026

(54) ENCODING AND DECODING SYSTEM AND METHODOLOGY TO COMPRESS COMPLEX COMBINATORIAL OPERATIONS OF OPERAND GROUPS

(71) Applicant: INVENSENSE, INC., San Jose, CA (US)

(72) Inventors: Vishal Vijayakumar, San Jose, CA (US); Juan Mejia Santamaria, San Jose, CA (US); Abbas Ataya, Menlo Park, CA (US)

(21) Appl. No.: 19/092,813

(22) Filed: Mar. 27, 2025

Related U.S. Application Data
(60) Provisional application No. 63/666,485, filed on Jul. 1, 2024.

(51) Int. Cl. G06N 20/20

(52) U.S. Cl. CPC G06N 20/20

(57) ABSTRACT

Devices and methods are provided that facilitate encoding and decoding of a one dimensional traversal vector for use in a wearable device. An ensemble network of nodes and node groups and combinatorial logic operations to be applied to them is provided by the customer, for example, via a graphical user interface. The ensemble is related to the operation of the wearable device. Off-line, the ensemble is converted into a chain equation and the chain equation is encoded into a one dimensional traversal vector. The traversal vector is then deployed to a chip on a wearable device where it is decoded to process real-time data.

### PRIORITY CLAIM

This patent application is a Non-Provisional Application that claims priority to U.S. Provisional Patent Application Ser. No. 63/666,485, filed Jul. 1, 2024, entitled “ENCODING/DECODING ALGORITHM TO COMPRESS COMPLEX COMBINATORIAL OPERATIONS OF OPERAND GROUPS,” the entirety of which is incorporated by reference herein.

### TECHNICAL FIELD

The subject disclosure relates generally to wearable devices and more specifically to machine learning for wearable devices.

### BACKGROUND

Wearable devices (WD) or wearable computing devices comprise a class of devices that are typically battery powered and comprise a central processing unit (CPU or processor). Examples of wearable devices include earbuds, wrist watches, and eyeglasses. Sometimes, smart phones and small computers can also be used as wearable devices. In addition to the processor, wearable devices can comprise further features, such as communications, display, and user interface (UI) abilities, input-output (IO), and the like, and they may be provided with an array of sensors to enable feature rich applications. Moreover, wearable devices or wearable computing devices are typically designed to be as small and unobtrusive as possible to facilitate comfort and usability without overly hindering a user's activities.

As a result, they typically operate with a resource constrained processor, meaning that the processor has only a small memory. Thus, wearable devices are limited to recognizing simple gestures and doing simple activity classification using memory-constrained algorithms such as one decision tree or other machine learning algorithms such as Support Vector Machines (SVM), linear regression, and mixture models. While complexity of gestures and activity classification can be increased by implementing multiple decision trees, their logical outputs cannot be combined in a scalable manner, meaning that combining them with current compression algorithms would lead to an exponential increase in storage complexity. That limits the diversity of solutions that can be implemented on the memory-constrained processor. The problem of encoding complex combination of operands and nodes is akin to encoding a sparse array. Meaning that the number of intermediate logical operations would be analogous to the number of dimensions in a sparse array. Moreover, using an algorithm to compress large decision trees does not solve the problem effectively, because the inherent if-then-else structure of any decision tree limits the complexity of solutions that can be implemented by a processor.

It is thus desired to provide improved wearable devices, designs and processes that address these and other deficiencies. The above-described deficiencies are merely intended to provide an overview of some of the problems of conventional implementations and are not intended to be exhaustive. Other problems with conventional implementations and techniques and corresponding benefits of the various aspects described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

Systems and methods for encoding and decoding a one dimensional traversal vector are disclosed. In various embodiments, initially, a graphical user interface (GUI) receives as an input a block diagram illustrating an ensemble network of a plurality of blocks and a plurality of logical operations associated with the plurality of blocks. The blocks and the logical operations together form numerous identifiable nests. The block diagram is then converted into a chain equation. The chain equation includes a chain of nests for corresponding to the block diagram, for the purpose of encoding the block diagram into a one dimensional traversal vector. The chain equation is formulated to be encoded from left to right. Each nest of the chain equation includes a logical operation to be performed on at least one of one pair of operands, at least one operand and one complex combination of operands, or at least one pair of complex combinations of operands. An encoder then converts the chain equation into a one dimensional traversal vector. The traversal vector shows an indicator indicating the beginning of the traversal vector, a plurality of indicators indicating beginnings of respective nests, operands, logical operations, one or more indicators indicating an ending of a nest, and an indicator indicating the end of the traversal vector. Digital files of the traversal vector are then prepared for facilitating deployment of the traversal vector to a remote processor. Upon deployment, the remote processor decodes the traversal vector by reading it from left to right. In some aspects, decoding involves incrementing a pointer to a deeper stack or decrementing it to a shallower stack according to pre-defined rules for elements of the traversal vector, thereby using only a small number of memory units.

These and other embodiments are described in more detail below.

### BRIEF DESCRIPTION OF THE DRAWINGS

Various non-limiting embodiments are further described with reference to the accompanying drawings in which:

FIG. 1 illustrates a block diagram of an exemplary, non-limiting apparatus, system or device that facilitates encoding and decoding a one dimensional traversal vector in accordance with one or more embodiments described herein;

FIG. 2 illustrates a block diagram of an exemplary inference environment in which the decoder is embedded in accordance with one or more embodiments described herein;

FIG. 3 depicts a simplified block diagram of an exemplary, non-limiting ensemble of data and combinatorial operations for encoding into the creation of a traversal vector in accordance with one or more embodiments described herein;

FIG. 4 depicts an exemplary sparse array for storing indices associated with the ensemble shown in FIG. 3.

FIG. 5 depicts graphs illustrating relationships between required storage space and number of variables to be encoded;

FIG. 6 depicts an example of an encoding algorithm in accordance with one or more embodiments described herein;

FIG. 7 depicts an example of a decoding algorithm in accordance with one or more embodiments described herein;

FIG. 8 illustrates a non-limiting flow diagram of exemplary decoding methodology for a traversal vector in accordance with one or more embodiments described herein;

FIG. 9 illustrates a non-limiting flow diagram of exemplary methodology for encoding and decoding a traversal vector in accordance with one or more embodiments described herein;

FIG. 10 illustrates a non-limiting flow diagram of exemplary methodology for encoding a traversal vector in accordance with one or more embodiments described herein;

FIG. 11 illustrates a non-limiting flow diagram of exemplary methodology for converting the chain equation into a one dimensional traversal vector in in accordance with one or more embodiments described herein;

FIG. 12 illustrates a block diagram of an example, non-limiting operating environment in which one or more embodiments described herein can be facilitated; and

FIG. 13 illustrates a sample computing environment operable to execute various implementations described herein.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems, and methodologies are intended to be encompassed within the scope of the subject matter disclosed herein.

As used herein, the terms node, node group, node value, and operand are used interchangeably, depending on the context. For example, node can refer to either the node label in the encoded one dimension traversal vector or the node value that is used on the wearable side while decoding the one dimension traversal vector. Embodiments of the present invention provide an end-to-end system and methodology for implementing a solution on a product such as a wearable device of small memory. Tasks and apparatus are distributed between off-line training and on-chip deployment. The encoding of the one dimension vector happens in an off-line environment and its decoding happens on-chip while the product is in the field. Initially, an ensemble network of combinatorial logic is introduced to the training environment. Inputs to the ensemble network can include inputs from decision trees, decision stubs, and complex combinations. The ensemble network can be provided by a maker of a wearable device and can be provided in block diagram form via a graphical user interface (GUI) to the training environment. The inputs to the ensemble network can be binary or non-binary. In either case, same types of combinatorial logical operations are applied to both types of inputs. By way of example, the result of 1 OR 0 logical operation is 1. For another example, the result of 1 AND 0 logical operation is 0. The ensemble network is then converted into a chain equation. Ensemble network to chain equation conversion can be done manually by a human, automatically by a computer, or semiautomatically by a combination of the two. The chain equation is then encoded into a one dimensional traversal vector, using devices and methods explained below in detail. The traversal vector is so named because it decodes the nodes of the ensemble network by accessing each node (walking through) in a predetermined sequence, for example, from left to right. One dimension refers to dimensionality of the vector, meaning, for example, each node of the ensemble network is visited once during the traversal (walk through) for encoding the vector. The encoded vector is then stored as a machine learning model (MLM) in one or more digital files of the training environment. The vector is then deployed on-chip and decoded there. The details of the decoding are explained below in detail.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### Exemplary Embodiments

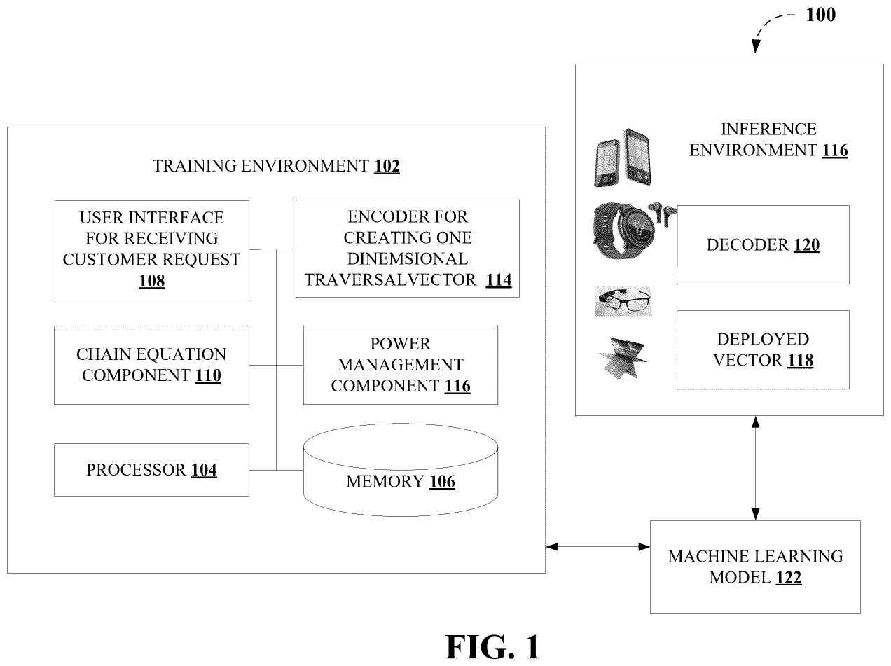

FIG. 1 illustrates a block diagram 100 of an exemplary, non-limiting apparatus, system or device that facilitates encoding or decoding of a one dimensional traversal vector in accordance with one or more embodiments described herein. The block diagram 100 illustrates a training environment 102, an inference environment 116, and a machine learning model (MLM) 122 that is deployed from the training environment 102 to the inference environment 116. The training environment 102 is used to encode the traversal vector. The encoded traversal vector can be deployed via MLM 122. The inference environment 116 is used to decode the traversal vector.

The training environment 102 can be referred to as an offline environment and can include a personal computer. The training environment includes a processor 104, memory 106, user interface (UI) 108, a chain equation component 110, an encoder 114, and power management component 116. UI 108 is for receiving customer requests, for example, block diagrams of combinatorial operations that are to be converted into a traversal vector. UI 108 can be communicable coupled to a network such as the Internet. The UI 108 can be capable of receiving input manually, for example, via a computer keyboard or a mouse, or can also be capable of receiving input via a microphone or a camera. The chain equation component 110 or the encoder 114 can be implemented in hardware, software or firmware. The chain equation component 110 converts the block diagram into a chain equation. The encoder 114 converts the chain equation into a one dimensional traversal vector. The traversal vector is then packaged into digital files for deployment. The traversal vector can be deployed as a part of MLM 122.

The inference environment 116 can be a wearable device such as a watch, an earbud, or eyeglasses. The inference environment 116 can also be a handheld device such as smart phone or a small computer. The inference environment can be equipped with one or more sensors including, for example, an infrared sensor, temperature sensor, accelerometer, gyroscope, environmental sensor, acoustic sensor, and camera. The inference environment includes the deployed vector 118 and the decoder 120 for decoding the vector 118. The decoder can be implemented in hardware, software, or firmware.

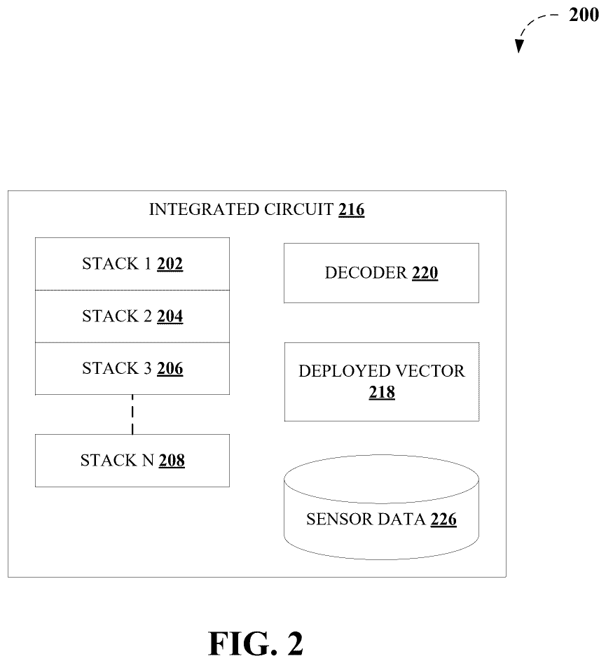

FIG. 2 illustrates a block diagram 200 of an exemplary, non-limiting inference environment 216 in accordance with one or more embodiments described herein. The inference environment 216 is an integrated circuit (IC). The IC 216 can be a processor, or a microprocessor embedded in a wearable device. Decoder 220 decodes traversal vector 218 and applies the sensor data 226 to the traversal vector 218. To decode traversal vector 218, decoder 220 uses one or more of the stacks 202, 204, 206 and 208, which are computer executable components stored in computer readable memory. Each stack 202-208 contains one or more memory units. A stack pointer points to the stack 202-208 that is to be used. A memory pointer points to the memory unit that is to be used. Decoder 220 is like decoder 120 shown in FIG. 1 and can be implemented inside a processor or as a separate computer executable component outside the processor. Decoder 220 can be implemented in hardware, software, or firmware.

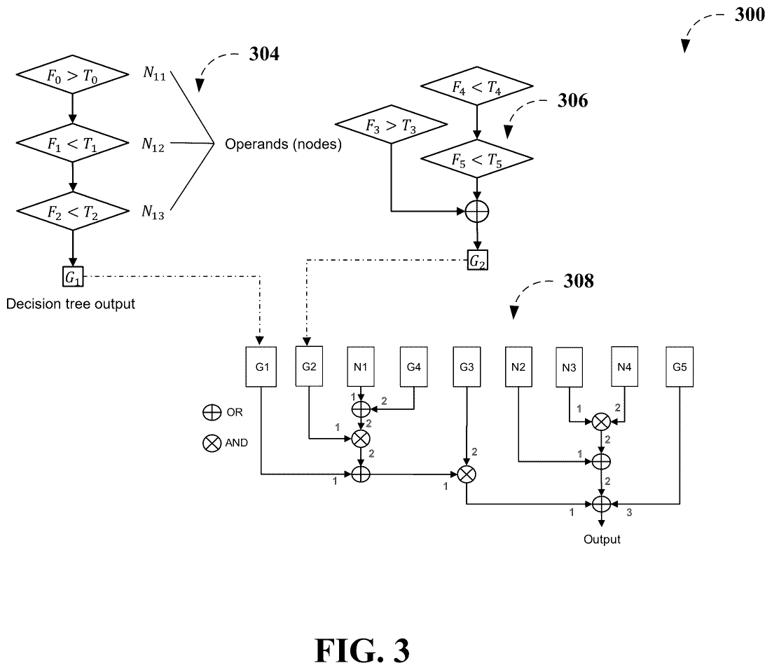

FIG. 3 illustrates a block diagram 300 of an exemplary, non-limiting ensemble of data and combinatorial operations for encoding into the creation of a traversal vector in accordance with one or more embodiments described herein. The block diagram 300 generalizes the type of logical operations that are requested to be encoded into MLM 122 as a one dimensional traversal vector. Information shown in block diagram 300 can be input via the UI 104. The block diagram 300 includes three components, namely, single decision tree 304, a complex tree network 306, and an ensemble of data and combinatorial operations 308. The single decision tree 304 has three operands or nodes N₁₁, N₁₂ and N₁₃ and produces the output G₁. Output G₁ becomes an input to the ensemble 308. The complex tree network 306 produces the output G₂. Output G₂ is produced by the OR logical operations and two operands, one operand being an output of a decision stub and the other operand being an output of a single decision tree. Output G₂ becomes an input to the ensemble 308. The ensemble 308 is shown to have nine inputs G1, G2, N1, G4, G3, N2, N3, N4 and G5. Each of these inputs can be data or an output of a tree or tree network. For example, each of these inputs can be from a car and can indicate whether a car is moving or still, whether brake is being applied or not, whether acceleration is above a particular threshold, and whether acceleration is below a particular threshold.

Combinatorial operations are performed on the inputs. For example, OR logic is applied to N1 and G4, and then AND logic is applied to its result and G2. These two logical operations can be referred to as first and second nests. NAND and NOR logic operations can also be applied in various ensembles. The example ensemble 308 has four OR logical operations and three AND logical operations. Countless other ensembles are possible, and they can be designed by customers. Customers can be makers of wearables or other products. Various ensembles can have varying number of inputs and varying number of nests. The ensemble 308 is shown to have an output. In another application, for example a car, the output can indicate whether the car is coasting or not upon analyzing via various nests whether the car is exhibiting signification acceleration or significant deceleration.

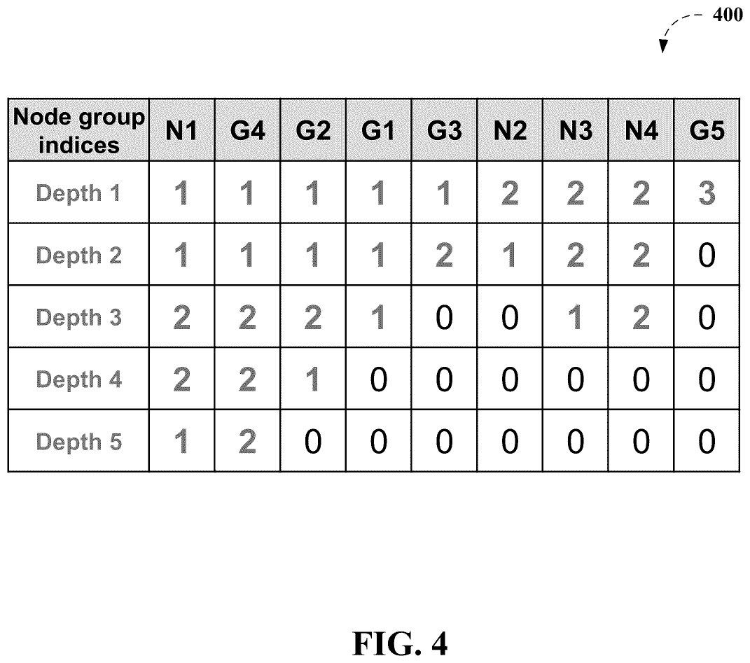

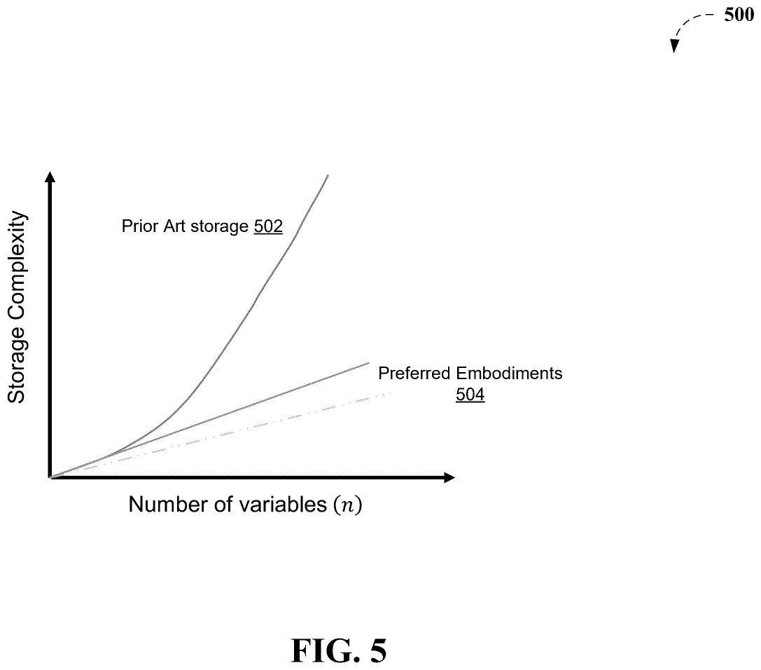

FIG. 4 illustrates an exemplary sparse array storage 400 for storing indices for the ensemble 308. Sparse array storage algorithms store the indices where at least one node group is present. Such algorithms do not scale linearly, and instead they scale exponentially. Array 400 has five indices labeled as depths 1-5. They are analogous to peeling an onion, one layer at a time. Index depth 5 is the innermost layer and represents the OR logical operation that receives values of N1 and G4 as inputs. Index depth 4 represents the AND logical operation that receives as inputs value of G2 and the result of the operation in depth 5. Index depth 3 is the OR logical operation that receives as inputs value of G1 and the result of the operation in depth 4, and the AND logical operation that receives values of N3 and N4 as inputs. Index depth 2 involves all logical operations except logical operations that result in the final output of ensemble 308. The final output of the ensemble 308 is represented by index depth 1. Each square in the array 400 that includes value 0, 1, 2, or 3 represents a memory unit. As can be seen, some memory units are wasteful in that they contain no value, meaning 0. These memory units must remain allocated to the array nonetheless and cannot be used for other tasks. As illustrated in FIG. 5, chart 500, graph labeled 502, the sparse array technique is burdensome in terms of storage capacity because it requires storage space that is exponential to the number of variables. The number of variables refers to the number of nodes and/or the number of nests in the block diagram that is to be encoded.

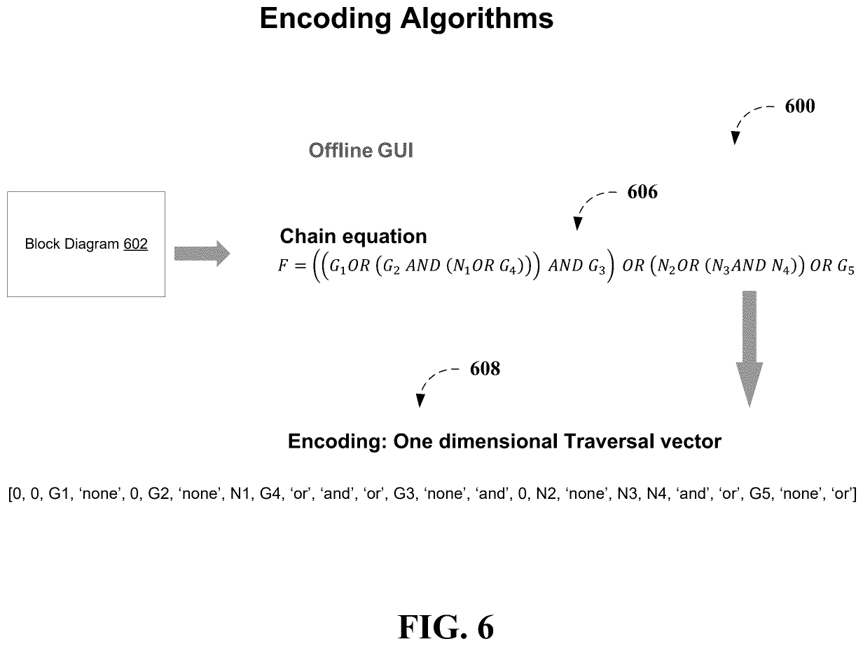

FIG. 6 depicts an encoding algorithm 600 in accordance with one or more embodiments described herein. The encoding can happen in an offline environment having a user interface, for example, a GUI. Block diagram 602 is converted into a chain equation 606. An example of the block diagram is depicted in FIG. 3. The chain equation shows all the nests of the ensemble 308 in an equation format. For example, depth 5 is shown as (N₁ORG₄) and depth 4 is shown as (G₂ AND (N₁ORG₄)). F refers to the final output of the ensemble.

The chain equation 606 is then encoded into a one-dimensional traversal vector 608. In the example of FIG. 6, vector 608 is designed as follows. Open square bracket indicates the start of vector 608 and closed square bracket indicates the end of vector 608. In other examples, ellipses or other types of brackets, quotation marks or symbols can be used instead of square brackets. Zeros (0s) are used to indicate start of a nested chain. The number of consecutive zeros encodes the depth of the nested chain. For example, the two 0s shown immediately following the open square bracket are encoding the two open parentheses that immediately follow the equal to (=) symbol in the chain equation 606. In other examples, numbers or symbols different from 0s can be used. Vector 608 shows nodes of the chain equation from left to right, namely G1, G2, N1, G4, G3, N2, N3, N4 and G5. The ‘none’ appearing after each of G1, G2, G3, N2 and G5 indicates that none of these nodes are initially grouped with any other node for performance of a combinatorial operation. For example, as can be seen in the chain equation, G1 is not grouped with another node initially, whereas N1 and G4 are grouped for performance of logical OR operation. String operations are

Vector 608 is designed such that a logical operation is meant to be applied to the two nodes that appear immediately before it. For example, the ‘or’ (logical OR) that appears immediately after N1, G4 is meant to be applied to values of N1 and G4. The ‘and’ (logical AND) that appears after the ‘or’ is meant to be applied to the result of the (N1 OR G4) operation and the value of G2. The exemplary nests shown in FIG. 6 only show two operands (nodes) at the most having one operation to be performed between them. However, in various examples, a nest can include more than two operands and more than two operations. Vector 608 is implemented in an MLM and deployed to a chip of a remote device, for example, a wearable device.

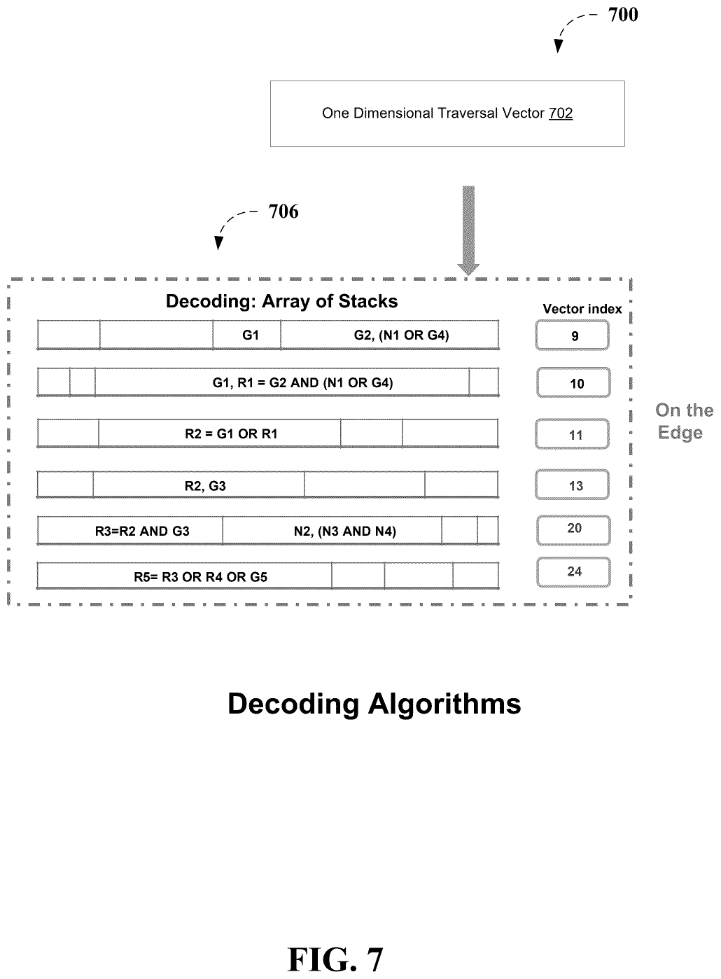

FIG. 7 depicts a decoding algorithm 706 in accordance with one or more embodiments described herein. Decoding can happen in an on-chip environment 700, for example, a wearable device that receives real time information that needs to be decoded. In environment 700, one dimensional vector 702 is deployed on a chip. Vector 702 can be the same vector as vector 608. Algorithm 706 decodes vector 702 by using an array of stacks. In the example, shown in FIG. 7, vector 702 is the same as vector 608 and there are four stacks. The four stacks are shown arranged horizontally. Upon receiving data, the wearable device uses the four stacks to decode vector 608 from left to right. In this example, in the first step of decoding, all operand values and operations up to and including vector index 9 are loaded in the five stacks. Each stack includes multiple memory units. Reading vector 608 from left to right, the first operation ‘or’ occurs immediately after the following nine quantities: 0, 0, G1, ‘none’, 0, G2, ‘none’, N1, G4. Thus, the ‘or’ is flagged as vector index 9. These nine quantities are loaded in the two rightmost stacks as these two stacks have enough memory units to store the nine quantities. The only operation, which is the logical OR operation, is then executed and the results and the value of G2 are loaded into the second stack from the right. G1 is already present in the second stack from the right.

In vector 608, the next operation is ‘and’, which is flagged as vector index 10. In the next step of decoding, which is the second row of array 706, logical AND is applied to the result of (N1 or G4) and that result is referred to as R1. In vector 608, the next operation is ‘or’, which is flagged as vector index 11. In the next step of decoding, which is the third row of array 706, G1 and R1 are loaded in the second stack from the left. All other stacks are empty. Logical OR operation is performed on G1 and R1 and the result is referred to as R2. In vector 608, the next operation is ‘or’, which is mentioned immediately after G3, none, and flagged as vector index 13. In the next step of decoding, which is the fourth row of array 706, R2 remains in the second stack from the left and value of G3 is added to that stack. In the next step of decoding, which is the fifth row of array 706, two stacks of the left are used. The two rightmost stacks remain empty. In the leftmost stack logical OR operation is applied to R2 and value of G3 and the result is referred to as R3. Also, in the second stack from left, value of N2 is loaded and logical AND operation is performed on values of N3 and N4. The result of the AND operation and value of N2 are then operated on with logical OR and the result of that operation is referred to as R4. This step is flagged as vector index 20. In the final step, flagged as vector index 24, the leftmost stack is used to generate the output of the ensemble 308 by performing logical OR operations between R3 and R4 and value of G5. That result is referred to as R5. Each row of combinatorial operations performed in the array 706 can referred to as string operations. Thus, each vector index is associated with a different string operation.

In different embodiments, the array can include different numbers of stacks. A custom decoder using fixed depth stack arrays based on size of encoded traversal vector is created. In some embodiments, the value of each of the operands G1, G2, N1, G4, G3, N2, N3, N4 and G5 is a binary value. In some embodiments, the values or one of more operands G1, G2, N1, G4, G3, N2, N3, N4 and G5 can be non-binary values. In these embodiments having non-binary values, such inputs are treated as multi-class classification inputs. Each node is assigned a class index by combining the node-group index with a class index. The number of bits used to encode such variables is pre-configured in advance. Non-binary inputs can be evaluated, for example, by bit-shifting left the node/node group index, then adding the class label index, then de-coupling and bit-shifting the encoded element to the right to obtain the node/node group index. In some embodiments, values of all operands G1, G2, N1, G4, G3, N2, N3, N4 and G5 are synchronously available, meaning at the same time. In some embodiments, values of the operands G1, G2, N1, G4, G3, N2, N3, N4 and G5 are asynchronously available, meaning they become available at different times. In these embodiments, there are situations in which intermediate outputs, for example, data from multiple sensors, are available at different points in time. For example, the example of car environment detection, acceleration, coasting, and braking event detections occur at different points in time. In that example, some portion of the one dimensional traversal vector can be decoded and then there can be a pause until more data becomes available, after which the decoding can resume. The implementation can be done, for example, by using Boolean output from a buffer to determine when to combine the intermediate outputs of node groups

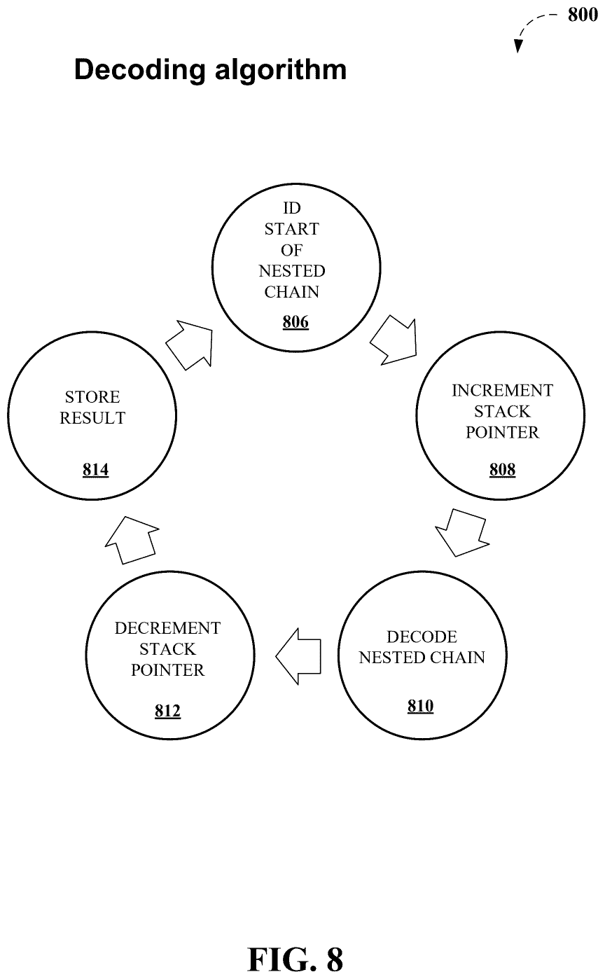

FIG. 8 illustrates a non-limiting flow diagram 800 of exemplary decoding methodology for a traversal vector in accordance with one or more embodiments described herein. At block 806, the start of a nested chain is identified. At block 808, the stack pointer is incremented. At block 810, the nested chain is decoded. For example, referring to FIG. 7, decoding happens when logical OR operation is performed on values of N1 and G4. At block 812, the stack pointer is decremented. At block 814, the result of the decoding is loaded to the stack to which the stack pointer is pointing. For example, referring again to FIG. 7, while the N1 OR G4 operation is performed in the rightmost stack, the result of the operation is loaded in the second stack from the right. Referring to FIG. 5, graph 504 shows results of the embodiments of the present invention. Graph 504 shows linear relationship between number of variables and storage requirement. That one dimensional traversal vector reduces the storage requirement from exponential to linear. The vector is product of compression algorithm for logical operations that scales linearly with the increasing number of operands and operators that add to the complexity. In prior art, as the increasing number of operands and operators multiply the storage complexity, memory overflows are caused even by small increases in the number of nodes or node groups.

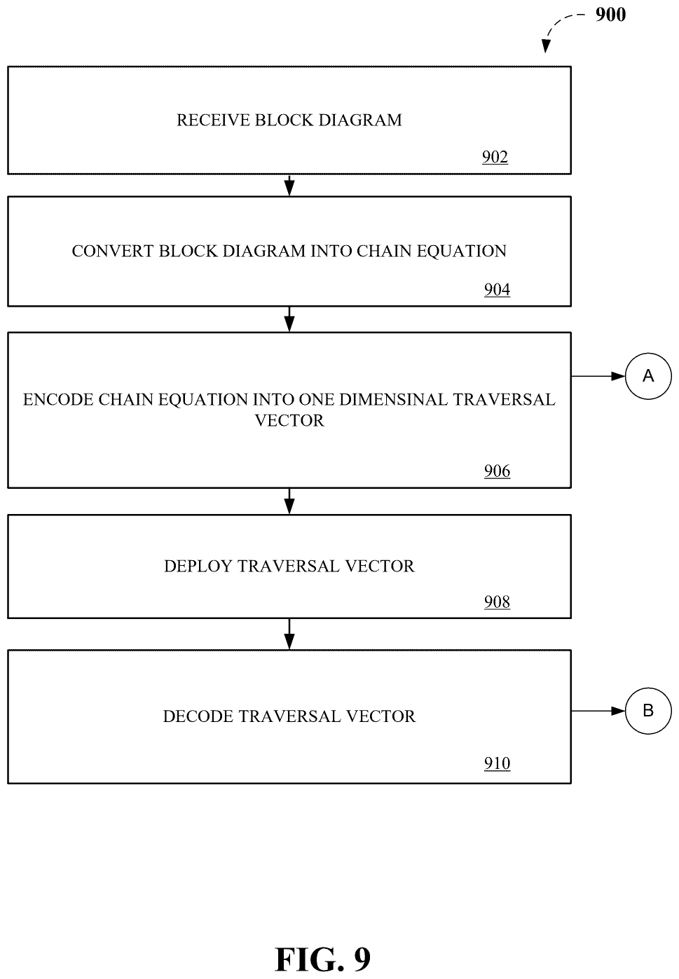

FIG. 9 illustrates a non-limiting flow diagram 900 of exemplary methodology for encoding and decoding a traversal vector in accordance with one or more embodiments described herein. At step 902, a block diagram of the ensemble to be encoded is received. At block 904, the ensemble is converted into a chain equation. At block 906, the chain equation is converted into a one dimensional traversal vector. At block 908, the traversal vector is deployed to a remote device. At step 910, the traversal vector is decoded on the remote device.

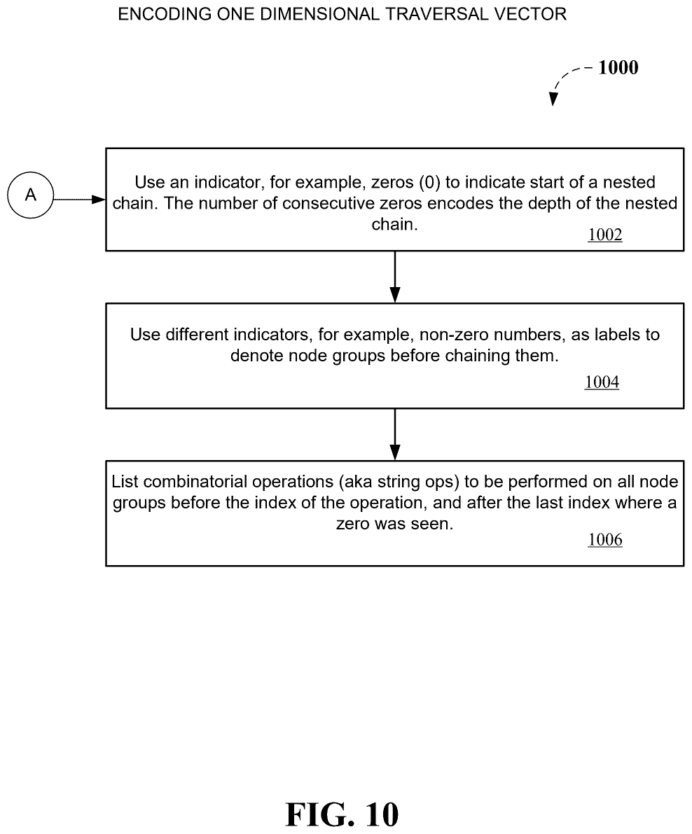

FIG. 10 illustrates a non-limiting flow diagram 1000 of exemplary methodology for converting the chain equation into a one dimensional traversal vector in accordance with one or more embodiments described herein. At step 1002, an indicator is used to indicate start of a nested chain. For example, the indicators can be zeros (0s). The number of consecutive zeros can encode the depth of the nested chain. At step 1004, node labels, for example, G1, G2, N1, are placed in the vector. They are not yet chained with logical operations and nests. At step 1006, chaining is done. Specifically, combinatorial operations (also known as string operations) to be performed are listed. A string operation refers to combinatorial operations that are to be performed on for all node groups before the following index of the operation, and after the previous index where the indicator zero was seen.

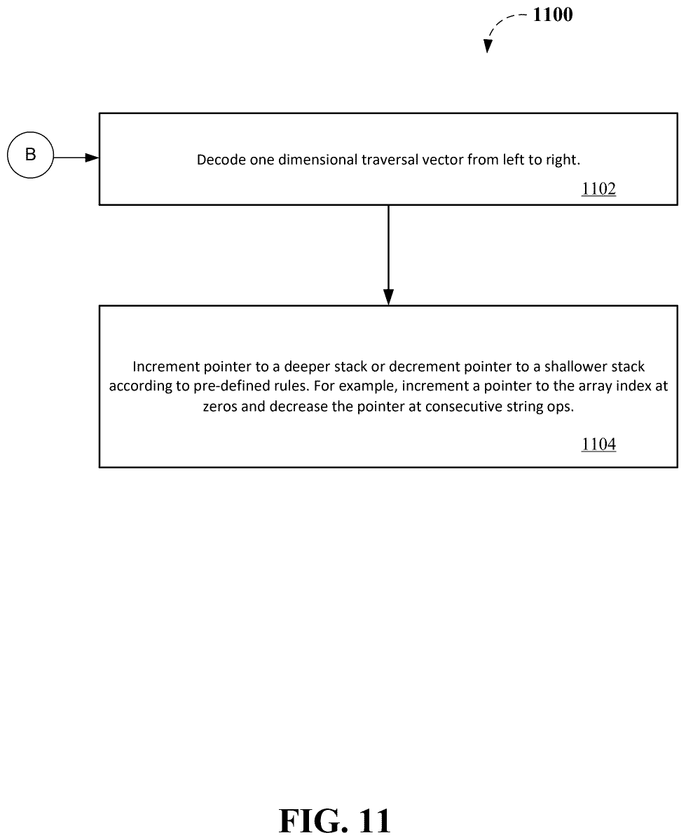

FIG. 11 illustrates a non-limiting flow diagram 1100 of exemplary methodology for decoding a traversal vector in accordance with one or more embodiments described herein. At step 1102, the one dimensional traversal vector is decoded from left to right. At step 1104, stack pointer is incremented to a deeper stack or decremented to a shallower stack according to pre-defined rules. For example, the rules can determine to increase the stack pointer upon detecting a zero and decreasing the stack pointed upon detecting two combinatorial operations.

### Exemplary Computing Environment

Various embodiments described herein can comprise or be associated with a computer-implemented system for creating and training of machine learning models for employment in devices or apparatuses that facilitate encoding and decoding of traversal vectors.

Those having ordinary skill in the art will appreciate that the herein disclosure describes non-limiting examples of various embodiments of the invention. For ease of description and/or explanation, various portions of the herein disclosure utilize the term “each” when discussing various embodiments of the invention. Those having ordinary skill in the art will appreciate that such usages of the term “each” are non-limiting examples. In other words, when the herein disclosure provides a description that is applied to “each” of some particular computerized object and/or component, it should be understood that this is a non-limiting example of various embodiments of the invention, and it should be further understood that, in various other embodiments of the invention, it can be the case that such description applies to fewer than “each” of that particular computerized object.

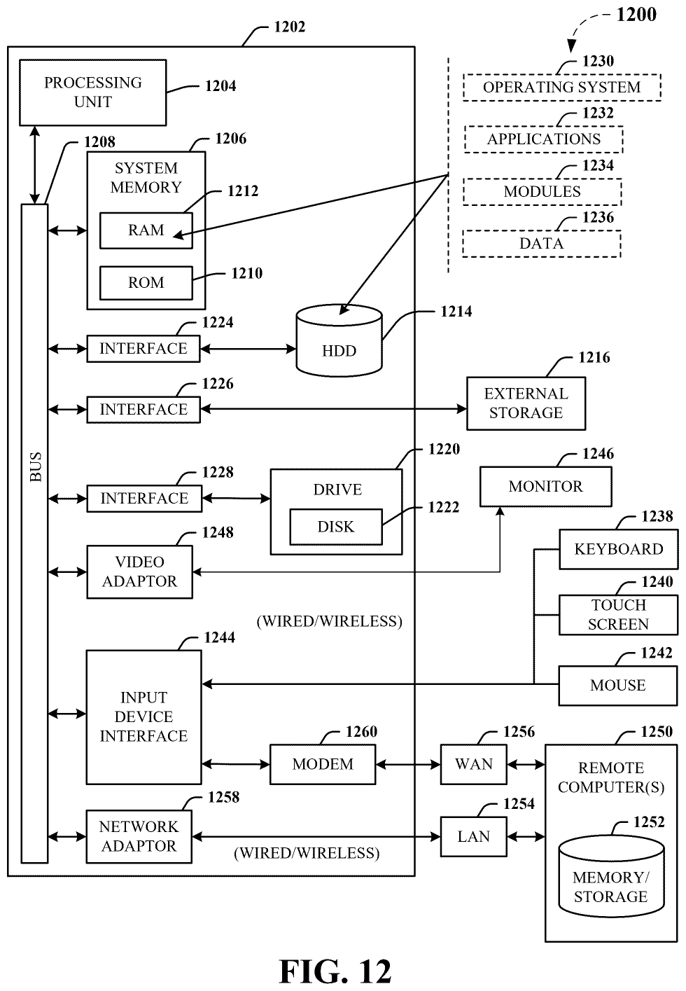

FIG. 12 illustrates a block diagram 1200 of an example, non-limiting operating environment in which one or more embodiments described herein can be facilitated. This environment is suitable for decoding the traversal vector because abundant resources are available. The decoding environment will only have some of these resources, as they are on a wearable device, and on a small scale. In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and a drive 1220, e.g., such as a solid state drive, an optical disk drive, which can read or write from a disk 1222, such as a CD-ROM disc, a DVD, a BD, etc. Alternatively, where a solid-state drive is involved, disk 1222 would not be included, unless separate. While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc. The monitor 1246 can provide the GUI via which the ensemble network is input into the system with assistance from keyboard 1238, touch screen 1240, and mouse 1242.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. The remote computer 1252 can be the wearable to which the one dimensional traversal vector is deployed for decoding. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above, such as but not limited to a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

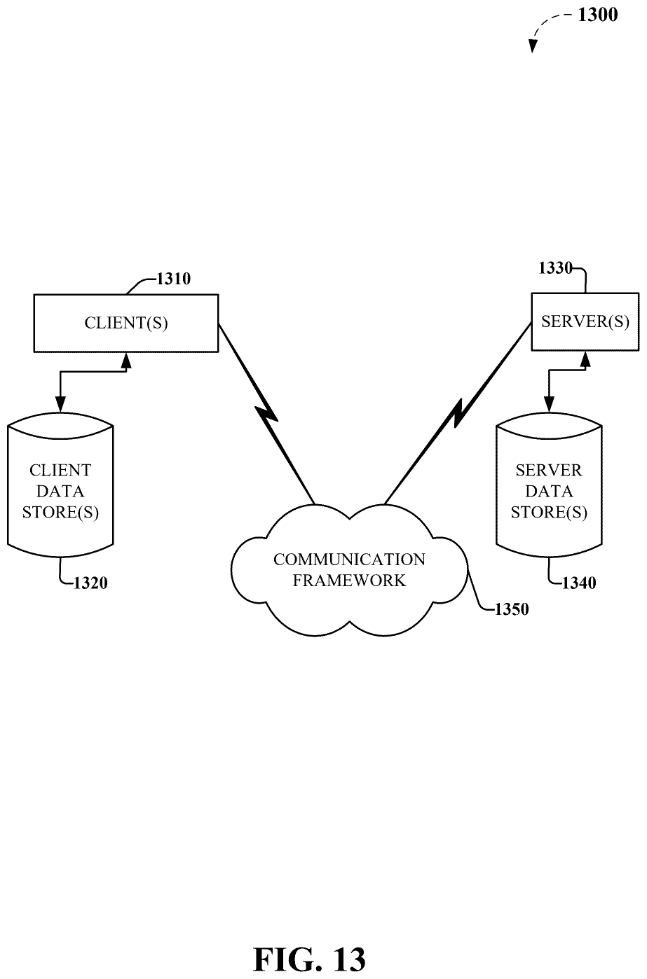

FIG. 13 illustrates a sample computing environment 1300 operable to execute various implementations described herein. The sample computing environment 1300 includes one or more client(s) 1320. The client(s) 1310 can be hardware and/or software (e.g., threads, processes, computing devices). The sample computing environment 1300 also includes one or more server(s) 1330. The server(s) 1330 can also be hardware and/or software (e.g., threads, processes, computing devices). The servers 1330 can house threads to perform transformations by employing one or more embodiments as described herein, for example. One possible communication between a client 1310 and a server 1330 can be in the form of a data packet adapted to be transmitted between two or more computer processes. The sample computing environment 1300 includes a communication framework 1350 that can be employed to facilitate communications between the client(s) 1310 and the server(s) 1330. The client(s) 1310 are operably connected to one or more client data store(s) 1320 that can be employed to store information local to the client(s) 1310. Similarly, the server(s) 1330 are operably connected to one or more server data store(s) 1340 that can be employed to store information local to the servers 1330.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a graphical user interface (GUI) configured to receive as an input a block diagram illustrating an ensemble network of a plurality of blocks and a plurality of logical operations associated with the plurality of blocks, wherein the blocks and the logical operations together form an identifiable number of nests;
a first component configured to convert the block diagram into a chain equation, wherein the chain equation illustrates a chain of nests for implementing the block diagram, wherein the chain equation is formulated to be executed from left to right, and wherein each nest includes a logical operation to be performed on at least one of a pair of operands, at least one operand and one complex combination of operands, or at least one pair of complex combinations of operands;
an encoder configured to convert the chain equation into a one dimensional traversal vector, wherein the traversal vector includes an indicator indicating the beginning of the traversal vector, a plurality of indicators indicating beginnings of respective nests, operands, logical operations, one or more indicators indicating an ending of a nest, and an indicator indicating the end of the traversal vector; and
a second component configured to prepare one or more digital files of the traversal vector for deployment of the traversal vector on a remote device.

2. The system of claim 1, further comprising:
the integrated circuit chip remotely situated from the encoder;
an array of stacks having a pointer situated on the chip, wherein the pointer points to the stack selected for storage of one of an operand, an operand and a complex combination of operands, a pair of operands and a logical operation to be performed on the pair, or a result of performing a logical operation;
the traversal vector deployed on the chip;
a decoder situated on the chip;
a third component configured to allocate a number of stacks for the decoder;
a fourth component configured to associate an operand with each block of the block diagram; and
a decoder configured to apply the traversal vector to the operands associated with the blocks of the block diagram; wherein,
the decoder is configured to read the traversal vector from left to right while decoding the traversal vector and the pointer is configured to increment to a deeper stack or decrement to a shallower stack according to pre-defined rules for elements of the traversal vector.

3. The system of claim 2, wherein the third component configured to allocate a number of stacks for the decoder equal to the identifiable number of nests or less than the identifiable number of nests.

4. The system of claim 2, further comprising: each stack of the array of stacks includes a plurality of memory units.

5. The system of claim 4, wherein each stack is configured to store up to one logical operation and up to three operands.

6. The system of claim 2, wherein there is a linear relationship between the number of allocated stacks and the number of operands associated with the block diagram.

7. The system of claim 2, further comprising: the decoder is configured to apply the traversal vector to the operands associated with the blocks of the block diagram asynchronously, wherein the operands can become available at different points in time.

8. The system of claim 2, wherein an operand is a binary number.

9. The system of claim 2, wherein a logical operation is one of an OR, an AND, a NOR, or a NAND operation.

10. The system of claim 2, wherein the integrated circuit chip is situated in a consumer electronics device.

11. The system of claim 1, wherein the complex combination includes two operands and a logical operation.

12. The system of claim 1, wherein the indicator indicating the beginning of the traversal vector is the left square bracket, the plurality of indicators indicating beginnings of respective nests are open round brackets, and the indicator indicating the end of the traversal vector is the right square bracket.

13. A method, comprising:
receiving a block diagram illustrating an ensemble network of a plurality of blocks and a plurality of logical operations associated with the plurality of blocks by using a graphical user interface (GUI), wherein the blocks and the logical operations together form an identifiable number of nests;
converting the block diagram into a chain equation, wherein the chain equation illustrates a chain of nests for implementing the block diagram, wherein the chain equation is formulated to be executed from left to right, and wherein each nest includes a logical operation to be performed on at least one of a pair of operands, at least one operand and one complex combination of operands, or at least one pair of complex combinations of operands;
encoding the chain equation into a one dimensional traversal vector, wherein the traversal vector includes an indicator indicating the beginning of the traversal vector, a plurality of indicators indicating beginnings of respective nests, operands, logical operations that are situated consecutively after the operands wherein each logical operation indicates an ending of a nest, and an indicator indicating the end of the traversal vector; and
preparing one or more digital files of the traversal vector for deployment of the traversal vector on a remote device.

14. The method of claim 13, further comprising:
deploying the traversal vector on a remote integrated circuit chip;
having an array of stacks having a pointer situated on the chip, wherein the pointer points to the stack selected for storage of one of an operand, an operand and a complex combination of operands, a pair of operands and a logical operation to be performed on the pair, or a result of performing a logical operation;
allocating a number of stacks to the decoder for applying the traversal vector;
associating an operand with each block of the block diagram; and
applying the traversal vector to the operands associated with the blocks of the block diagram; wherein,
the pointer to the is configured to increment to the next stack in the array upon detection of an indicator indicating a beginning of a nest and decreasing to the previous stack in the array upon detection of a second consecutive logical operation.

15. The method of claim 14, wherein allocating a number of stacks for the decoder equal to the identifiable number of nests or less than the identifiable number of nests.

16. The method of claim 14, further comprising: applying the traversal vector to the operands associated with the blocks of the block diagram asynchronously, wherein the operands can become available at different points in time.

17. The method of claim 13, wherein the complex combination includes two operands and a logical operation.

18. The method of claim 13, wherein the indicator indicating the beginning of the traversal vector is the left square bracket, the plurality of indicators indicating beginnings of respective nests are open round brackets, and the indicator indicating the end of the traversal vector is the right square bracket.

19. An integrated circuit chip, comprising:
a memory location for storing a one dimensional traversal vector, wherein the traversal vector includes an indicator indicating the beginning of the traversal vector, a plurality of indicators indicating beginnings of respective nests, operands, logical operations that are situated consecutively after the operands wherein each logical operation indicates an ending of a nest, and an indicator indicating the end of the traversal vector;
an array of stacks having a pointer situated on the chip, wherein the pointer points to the stack selected for storage of one of an operand, an operand and a complex combination of operands, a pair of operands and a logical operation to be performed on the pair, or a result of performing a logical operation; and
a processor for executing the traversal vector by using the array of stacks, the pointer is configured to increment to the next stack in the array upon detection of an indicator indicating a beginning of a nest and decreasing to the previous stack in the array upon detection of a second consecutive logical operation; wherein,
the traversal vector is formulated by converting a chain equation illustrating a chain of nests and wherein each nest includes a logical operation to be performed on one of a pair of operands, an operand and a complex combination of operands, or a pair of complex combinations of operands.

20. The integrated circuit chip of claim 19, further comprising: the integrated circuit chip is implemented in a consumer electronics device.
